(19) United States
(12) Patent Application Publication
(10) Pub. No.: US 2016/0322149 A1
(43) Pub. Date: Nov. 3, 2016

(54) Method for Controlling Load of Transformer Based on Hot Spot Temperature Measured by Using Fiber Grating Technology

(71) Applicants: TAIYUAN POWER SUPPLY COMPANY OF STATE GRID SHANXI ELECTRIC POWER COMPANY, Taiyuan, Shanxi (CN); WUHAN NARI LIMITED LIABILITY COMPANY OF STATE GRID ELECTRIC POWER RESEARCH INSTITUTE, Wuhan, Hubei (CN); STATE GRID CORPORATION OF CHINA, Beijing (CN)

(72) Inventors: Junliu ZHANG, Wuhan (CN); Guohua ZHOU, Wuhan (CN); Lijuan XIONG, Wuhan (CN); Xin GAO, Wuhan (CN); Ronggui GAO, Wuhan (CN); Dong YANG, Wuhan (CN); Shanshan WANG, Wuhan (CN); Siyuan LIANG, Wuhan (CN)

(21) Appl. No.: 14/901,710

(22) PCT Filed: Nov. 28, 2013
(86) PCT No.: PCT/CN2013/088033

§ 371 Date: Dec. 28, 2015

(30) Foreign Application Priority Data
Jun. 28, 2013 (CN) 201310265429.9

(51) Int. Cl. H01F 27/08; H01F 27/28; H01F 27/24; G01K 11/32; H01F 41/02

(52) U.S. Cl. CPC H01F 27/08; G01K 11/3206; H01F 41/0246; H01F 27/24; H01F 27/28

(57) ABSTRACT

A method for controlling the load of a transformer based on a hot spot temperature measured by using the fiber grating technology. In the production process of a transformer, fiber grating sensors are arranged on the upper portion of an internal winding of the transformer, at the position of a leading wire and on the upper portion of an iron core, and the control of a cooler of the transformer is directed by using real-time temperature data measured by the fiber grating sensors. In this method, the fiber grating sensors are used to monitor the internal hottest spot temperature of the transformer to conduct the cooling control of the transformer, so that the control of a cooling system of the transformer can be conducted effectively in accordance with the operation state of the transformer itself and the influence of the external environment.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to an automatic controlling method of a transformer cooler of a power transmission and transformation equipment, and more particularly to a method for monitoring a temperature on the hottest spot inside the transformer and controlling an operation of the transformer cooler by using a fiber grating temperature measuring system.

2. Description of Related Arts

A power transformer is an important equipment in the modern electric power system. The internal winding temperature of the power transformer has a direct influence on a life span of the power transformer and an operation security of a power transmission and transformation system. As a result, the temperature of the transformer in each transformer station needs to be monitored. The insulativity and ageing rate of the transformer are related to the hot-spot temperature of an internal winding. If the hot spot temperature of the internal winding exceeds an allowable threshold, it will not only reduce the operating life span of the transformer, but also pose a threat to the operation security of the transformer. If the hot spot temperature of the internal winding is too low, the capacity of the transformer will be underutilized and the economic efficiency will be reduced. The Maximum threshold of temperature rise of the transformer is based on the service life span of the transformer (mainly based on the service life of insulating materials). The maximum threshold of temperature rise or hot spot temperature of the transformer under different load operating conditions has been specified in corresponding regulations in the relevant national standards. In an article entitled of “Part 2 of Power Transformer: Temperature Rise” of the power transformers national standard GB1094.2-1996, the stipulated maximum thresholds of temperature rise of the transformer are determined by different loading conditions. Therefore, the method of internal temperature detection of the transformer based on fiber grating is particularly critical in the process of transforming an electric power system into a smart grid. Using the system to accurately measure and monitor the real-time internal winding hot spot temperature has important practical significance.

The transformer produces a lot of heat during operation, the internal temperature of the transformer rises rapidly, and thus resulting in an accelerated aging of the insulation system of the transformer. The equipment may be damaged due to high temperature or even result in an emergency such as an explosion. The cooling system of a large oil-immersed transformer generally uses forced oil-circulation air cooling cooler or forced oil-circulation water cooling cooler. The current control method mainly uses the oil temperature at top of the transformer as a judgment basis so as to adjust the transformer cooler. However, this method has the following main drawbacks.

Firstly, merely monitoring the top-level temperature of the transformer cannot fully show the actual situation inside the transformer.

Secondly, the current primary control method is to adjust the number of operating transformer coolers to regulate its internal temperature when the oil temperature at the top of the transformer reaches a certain temperature. This method cannot regulate the internal temperature of the transformer smoothly.

Thirdly, the coolers of the transformer are frequently started and paused corresponding to the change of internal temperature. This is prone to create a switch failure of the transformer. As several groups of coolers turn on and off simultaneously, sometimes it is hard to control the cooling system in accordance with the hot spot locations of the transformer effectively and in real-time. As a result, partial areas inside of the transformer may have an accelerated aging rate because of the high temperature at the partial areas and the transformer may even be damaged.

A China Patent Application No. CN200810014398.9 which has a title of “Control apparatus for automatic shifting and switching of transformer cooling system” discloses an automatic shifting and switching control device of a transformer cooling system. The automatic shifting and switching control device of the transformer cooling system includes a mini industrial control computer, a remote alarm module and a plurality of monitoring and control modules. One end of each monitoring and control module is connected with the mini industrial control computer through R485 field buses, and the other end thereof is connected with a control logic and indicating circuit of the cooling system. The remote alarm module is connected with the control logic and indicating circuit of the cooling system. The device of that invention only designs a strategy for the shifting and switching control device, it cannot monitor the internal temperature of the transformer and adjust the cooling system effectively and in real-time.

In view of above, it is necessary to develop a method for controlling the load of a transformer based on a hot spot temperature measured by using the fiber grating technology which can fit the needs of practical applications.

### SUMMARY OF THE PRESENT INVENTION

The main object of the present invention is to overcome the above mentioned disadvantages and provide a method using a plurality of fiber grating sensors to monitor the internal hottest spot temperature of the transformer to conduct the cooling control of the transformer, so that the control of a cooling system of the transformer can be conducted effectively in accordance with the operation state of the transformer itself and the influence of an external environment, thereby achieving the purpose of avoiding the generation of faults and the acceleration of insulation ageing caused by the high temperature in the transformer.

Additional advantages and features of the invention will become apparent from the description which follows, and may be realized by means of the instrumentalities and combinations particular point out in the appended claims.

According to the present invention, the foregoing and other objects and advantages are attained by a method for controlling the load of a transformer based on a hot spot temperature measured by using the fiber grating technology, wherein in a manufacturing process of a transformer, a plurality of fiber grating sensors is arranged on an upper portion of an internal winding of the transformer, at a position of a leading wire and on an upper portion of an iron core for measuring real-time temperature data, so as to conduct a control a transformer cooler, wherein the method comprises the following steps.

(A) During the manufacturing process of the transformer, arrange a plurality of the fiber grating sensors at a position optical fiber at a position of the internal winding and in an optical fiber at a position of the leading wire of the transformer, and lead the fiber grating sensors to outside by the optical fiber at the position of the internal winding.

(B) During the manufacturing process of the transformer, mount a plurality of fiber grating sensors on the position of the iron core of the transformer, and arrange the fiber grating sensors at the upper portion of the iron core by all means.

(C) Manufacture a core and winding body assembly which has installed with the fiber grating sensors in accordance with a normal manufacturing process; begin a transformer temperature rise test when the above manufacturing process is completed; monitor in full time and in real-time during the temperature rise test; collecting internal temperature changes data of the transformer and record information which are corresponding to one or more of the fiber grating sensors; find out an internal hottest spot temperature of the transformer and record a data of the hot spot temperature of the transformer by using the sensor fiber gratings after finishing the transformer temperature rise test; record the data of the hot spot temperature as T during the later operational process, wherein T is a parameter which represents a measured highest value or an average value of the hot spot temperature.

(D) Establishing a coolers controlling strategy, wherein the strategy comprising the following steps.

(a) Turn off all of the coolers when T <60° C., in such a manner that a heat-sink cooling effect merely relies on a heat dissipating effect of an insulating oil of the transformer.

(b)Turn on a first cooler when T =60° C.

(c)Turn on one more coolers for every additional 10° C. when T>60° C. until all of the coolers are completely turned on.

(d) Overhaul the transformer when T>130° C.

The invention is advantageous in that the method employs a plurality of fiber grating sensors to monitor the internal hottest spot temperature of the transformer to conduct the cooling control of the transformer, so that the control of a cooling system of the transformer can be conducted effectively in accordance with the operation state of the transformer itself and the influence of an external environment, thereby achieving the purpose of avoiding the generation of faults and the acceleration of insulation ageing caused by the high temperature in the transformer.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic view illustrating the arrangement of the fiber grating sensors in the winding according to a preferred embodiment of the present invention.

FIG. 2 is a schematic view illustrating the arrangement of the fiber grating sensors on the iron core according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Reference characters in the drawings are illustrated as follows: 1-winding, 2-fiber grating sensor, 3-optical fiber, 4-fiber grating sensor, 5-iron core, 6-fiber grating sensor, 7-optical fiber, and 8-return yoke.

During a manufacturing process of a transformer, one or more fiber grating sensors are mounted at an inner side of the transformer at positions where there may be the hottest spots such as an upper portion of an internal winding, an upper portion of the iron core, a position in an oil duct, and a position of a leading wire. As the fiber grating sensor is small in size and it is able to be directly mounted inside the optical fiber, thus it is easy for mounting the fiber grating sensors is the transformer, so as to act as monitoring devices.

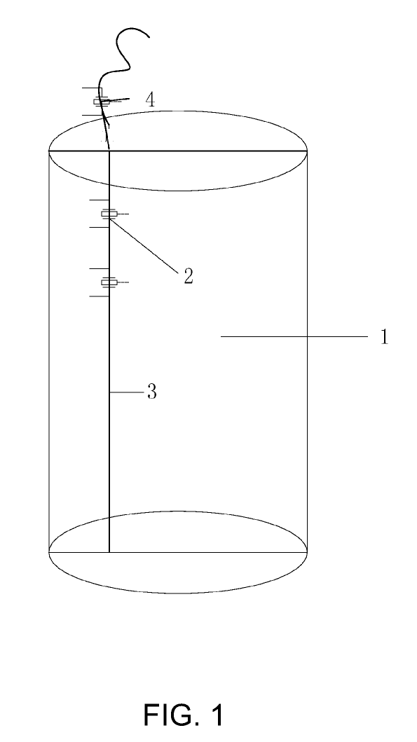

As shown in FIG. 1, and internal winding and fiber grating sensors 2 and 4 for the winding and leading wire are mounted at a position corresponding to an optical fiber 3 of the winding. The two fiber grating sensors 2, 4 are respectively arranged at the internal winding 1 and leading wire during the manufacturing process of the transformer, and are leaded to the outer side by the optical fiber 3 at the position corresponding to the winding. It is worth mentioning that the fiber grating sensors are preferably arranged on an upper portion of the internal winding 1. It should be noticed that the optical fiber 3 at the position corresponding to the winding is easily damaged during installation.

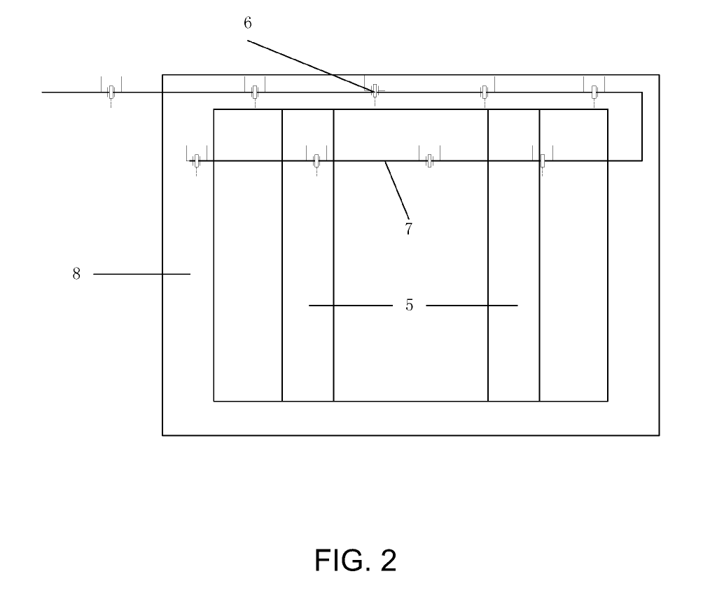

As shown in FIG. 2, a plurality of fiber grating sensors 6 is mounted on the iron core corresponding to an optical fiber 7 thereof, the fiber grating sensors 6 are arranged on an upper portion of the iron core 5. It is worth mentioning that there should be arranged with as many as possible fiber grating sensors. It should be noticed that the optical fiber 7 at the position corresponding to the iron core 5 is easily damaged during installation.

A core and winding body assembly which has the installed fiber grating sensors 2, 4 and 6 is produced in accordance with the normal manufacturing process. It is worth mentioning that the optical fibers 3 and 7 in the manufacturing process should not be damaged.

A transformer temperature rise test begins when the above manufacturing process is completed. There is a full-time and real-time monitoring process during the test to collect the internal temperature changes of the transformer and to record information corresponding to one or more fiber grating sensors. The hottest part inside of the transformer by using the sensor fiber gratings after finishing the transformer temperature rise test is found out and recorded. The temperature is recorded as T during the subsequent operation process (the temperature is the measured highest value or an average value).

The operating unit applies cooler control strategies during operational process as follows:
(a) turning off all of the coolers when T<60° C., in such a manner that a heat-sink cooling effect merely relies on a heat dissipating effect of an insulating oil of the transformer ;
(b) Turning on a first cooler when T=60° C.;
(c) Turning on one more coolers for every additional 10° C. when T>60° C. until all of the coolers are completely turned on; and
(d) Overhauling the transformer when T>130° C.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for controlling a load of a transformer based on a hot spot temperature measured by using a fiber grating technology, wherein in a manufacturing process of said transformer, a plurality of fiber grating sensors is arranged on an upper portion of an internal winding of said transformer, at a position of a leading wire and on an upper portion of an iron core for measuring real-time temperature data, so as to conduct a control a transformer cooler, wherein the method further comprises the steps of:
(A) during said manufacturing process of said transformer, arranging a plurality of said fiber grating sensors at an optical fiber at a position of said internal winding and at an optical fiber at a position of said leading wire of said transformer, and leading said fiber grating sensors to outside by said optical fiber at the position of said internal winding;
(B) during said manufacturing process of said transformer, mounting a plurality of said fiber grating sensors at an optical fiber corresponding to said iron core of said transformer, and arranging said fiber grating sensors at an upper portion of said iron core;
(C) manufacturing a core and winding body assembly which has installed with said fiber grating sensors in accordance with a normal manufacturing process; beginning a transformer temperature rise test when the above manufacturing process is completed; monitoring in full time and in real-time during said temperature rise test; collecting internal temperature changes data of said transformer and recording information corresponding to one or more of said fiber grating sensors; finding out an internal hottest spot temperature of said transformer and recording a data of said hot spot temperature of said transformer by using said sensor fiber gratings after finishing said transformer temperature rise test; recording said data of said hot spot temperature as T during said later operational process, wherein T is a parameter which represents a measured highest value or an average value of said hot spot temperature; and
(D) establishing a coolers controlling strategy, wherein said strategy comprising the steps of:
(a) turning off all of coolers when T<60° C., in such a manner that a heat-sink cooling effect merely relies on a heat dissipating effect of an insulating oil of said transformer;
(b)turning on a first cooler when T=60° C.;
(c)turning on one more coolers for every additional 10° C. when T>60° C. until all of said coolers are completely turned on; and
(d) overhauling the transformer when T>130° C.
